(19) United States
(12) Patent Application Publication
(10) Pub. No.: US 2009/0241121 A1
(43) Pub. Date: Sep. 24, 2009

(54) Device, Method and Computer Program Product for Monitoring Collaborative Tasks

(76) Inventors: Gil Nechushtai, Atlit (IL); Yoav Ossia, Haifa (IL); Avi Yaeli, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/963,882

(22) Filed: Dec. 24, 2007

(51) Int. Cl. G06F 9/50

(52) U.S. Cl. 718/104; 718/100

(57) ABSTRACT

A method for controlling collaborate tasks, the method includes: receiving a request to initiate a collaborative task that is associated with an assignment; and responding to the request in response to an assignment resource utilization policy.

### FIELD OF THE INVENTION

The present invention relates to a method, a device and a computer program product for monitoring collaborative tasks and especially for monitoring resources utilized during a fulfillment of collaborative tasks in relation to an assignment.

### BACKGROUND OF THE INVENTION

Collaborative tasks enable different people to collaborate. The collaboration can be aimed to complete an assignment. Typical collaborative tasks can include exchanging emails, participating in meetings, participating in conference calls, participating in instant messaging sessions, and the like.

Various state of the art collaborative tools such as Lotus Notes™, Lotus Sametime™ of IBM as well as other collaborative tools are extensively used by members of organizations through out the world. It is noted that collaborative tools may also include collaborative (or workflow) based applications such as but not limited to software development tool platform that uses several tools to enable analyst, designer, developer, tester, etc to collaborate in building a software product.

These collaborative tools are not adapted to monitor the amount of time spent by the members in relation to various assignments.

Organizations are forced to optimize (or at least improve) the utilization of their resources. Collaborative tasks tend to consume a large amount of time and effort.

There is a growing need to monitor collaborative tasks and especially resources consumed during collaborative tasks.

### SUMMARY OF THE PRESENT INVENTION

A method for controlling collaborate tasks, the method includes: receiving a request to initiate a collaborative task that is associated with an assignment; and responding to the request in response to an assignment resource utilization policy.

### BRIEF DESCRIPTION OF THE DRAWINGS

The present invention will be understood and appreciated more fully from the following detailed description taken in conjunction with the drawings in which:

FIG. 1 illustrates a system for controlling collaborative tasks, according to an embodiment of the invention;

FIG. 2 illustrates various data structures according to an embodiment of the invention;

FIG. 3 is a flow chart of a method for controlling collaborative tasks according to an embodiment of the invention; and

FIG. 4 is a flow chart of a method for monitoring collaborative tasks according to an embodiment of the invention.

### DETAILED DESCRIPTION OF THE DRAWINGS

The present invention provides a method, device and computer program product for controlling collaborative tasks. Requests to initiate a collaborative task (that is associated with an assignment) can be approved, rejected or amended according to: (i) resources that are going to be utilized during the requested collaborative task, (ii) resources already consumed in relation to the assignment, and (iii) assignment resource utilization policy.

The present invention provides a method, device and computer program product for monitoring collaborative tasks. Collaborative tools provide information representative of multiple collaborative tasks and information representative of one or more assignments associated with the collaborative tasks. This information is processed in order to estimate resources utilized in relation to at least one assignment.

Conveniently, a computer network connects multiple computerized entities and storage devices to enable multiple persons to use collaborative tools, and also to perform resource utilization monitoring and additionally or alternatively resource utilization control. It is noted that one or more central servers can perform the monitoring and/or the controlling.

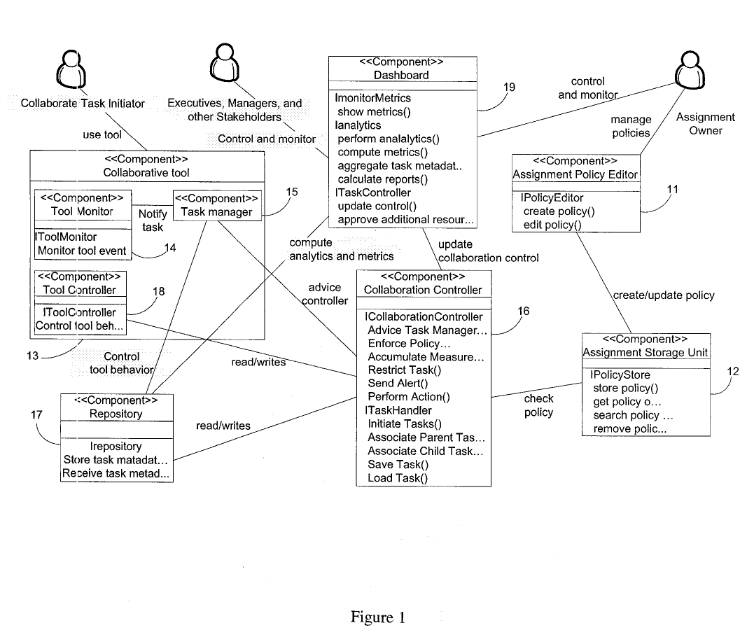

FIG. 1 illustrates system 10 according to an embodiment of the invention.

System 10 may include hardware and software modules. System 10 includes: collaboration controller 16, assignment storage unit 12, repository 17, dashboard 19, assignment policy editor 11 and collaborative tool 13. Each of these components can include software, hardware and/or firmware modules. Each of these components can be implemented in a distributed, partially distributed or centralized manner. Typically, each user can utilize one or more collaborative tools and multiple collaborative tools can be connected to a single collaboration controller. For simplicity of explanation only a single collaborative tool (13) is shown.

Collaborative tool 13 includes tool monitor 14, tool controller 18 and task manager 15. Task manager 15 provides an interface between collaborative tool 13 and collaboration controller 16. It can, for example, translate collaborative task information (such as resource utilization) to a format readable by collaboration controller 16, it can determine when collaborative tool receives information relating to a collaborative task that was already initiated (for example—replying to emails, forwarding emails, accepting or rejecting an invitation to participate in a meeting, and the like). Collaboration controller can be viewed as a governance module that enforces an application resource utilization policy.

The following sample scenario illustrates the manner in which some of the mentioned above components operate.

In order to control the utilization of resources in relation to an assignment a policy (referred to as assignment resource utilization policy) should be defined. A person (referred to as an assignment owner) can decide, for example, to limit the time spent by managers of an organization on a certain public relation assignment (referred to as assignment X). The assignment owner uses assignment policy editor 11 to create (or update) an assignment resource utilization policy that should be applied in relation to assignment X. The policy can include one or more assignment resource utilization rules.

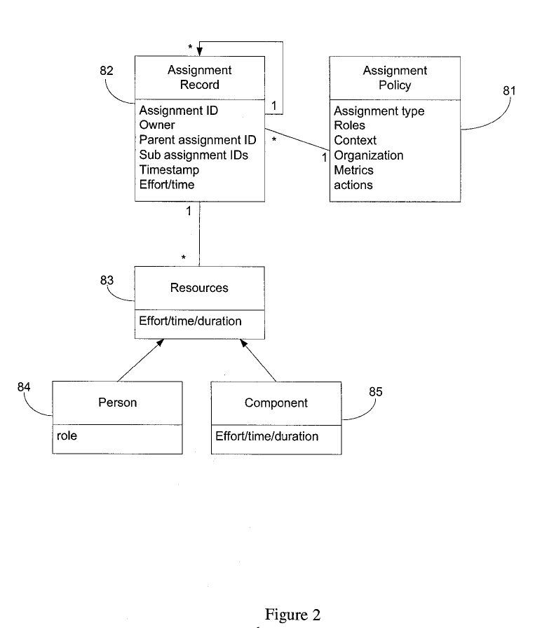

The assignment resource utilization policy related to assignment X is stored in assignment storage unit 12. FIG. 2 illustrates various data structures including assignment record 82 that is created and is stored in assignment storage unit 12.

After the assignment resource utilization policy is defined various people can request to initiate a collaborative task that is associated with assignment X.

A person (referred to as a collaborative task initiator) can request to initiate a collaborative task that is associated with assignment X. He can use collaborative tool 13 to generate a request to initiate such a collaborative task. The request can be evaluated by collaboration controller 16. The collaborative task can be, for example, kickoff meeting of assignment X.

It is noted that the association between the collaborative task and the assignment X can be done automatically, for example, by collaborative tool 13. The automatic association can be responsive to context such as but not limited to text included in the request, the name of the collaborative task, the role of the assignment owner, previous collaborative tasks initiate by the assignment owner, and the like. Additionally or alternatively, the assignment owner can indicate that the collaborative task is associated with assignment X.

Conveniently, tool monitor 14 detects the request to initiate the collaborative task and notifies task manager 15. Tool monitor 14 can also send context information.

Task manager 15 then sends the request to collaboration controller 16. Collaboration controller 16 can determine how to respond to the request.

Collaboration controller 16 can retrieve the assignment resource utilization policy that relates to assignment X from assignment storage unit 12 and can also retrieve (from repository 17) information relating to resources that were presumably utilized in relation to assignment X. It is noted that collaboration controller 16 can use context information to locate the relevant policy. After the information was retrieved, collaboration controller 16 can determine how to respond to the request in view of the retrieved information as well in view of the resources that could be utilized to fulfill the requested collaborative task.

Collaboration controller 16 can refuse to initiate the collaborative task, suggest to amend the collaborative task such as to alter resources to be consumed during the fulfillment of the task; amend the collaborative task such as to alter resources to be consumed during the fulfillment of the collaborative task; request an authorization to initiate the collaborative task despite a possible policy violation, and additionally or alternatively, generate an alert.

If the request is approved then collaboration controller 16 creates various data structures that are illustrated in FIG. 2. Collaborative controller 16 creates task record 84 and associates it with the list 86 of persons that are invited to participate in the collaborative task (for example—managers that are invited to attend the kick off meeting), and a record 85 of resources to be utilized during the fulfillment of the collaborative task (during the kickoff meeting). It is noted that these data structures (84, 85, 86, 87) can be associated to each other a-priori or afterwards (for example- after the compliance of invited managers to the kick off meeting is known), and the like. These data structures are conveniently stored in repository 17.

Collaboration controller 16 notifies task manager 15 about its determination. If, for example the request is approved task monitor 14 and tool controller 18 are notified. Tool controller 18 can complete the initiation of the collaborative task by sending invitations to participate in the collaborative task (participate in the kick off meeting). The invitation includes collaborative task information and also includes (or is otherwise associated with) information representative of assignment X.

The collaborative task initiator can be informed about the decision made by the collaboration controller 16.

The initiation of the collaborative task can include inviting people to participate in that collaborative task. People can respond to the invitation by accepting the invitation, rejecting the invitation, and the like. Their responses can be used to update the repository. Typically, such an invitation is detected by the task managers of these other people, and when these people respond to the invitation their collaborative tools send to collaboration controller 16 information representative of the resources to be utilized in relation to assignment X.

It is noted that an alert (or rejection) can be triggered if a user sends invitation to re-occurring meeting that involve many people.

Dashboard 19 can be used to initiate analysis of resource utilization. It can be used for analyzing resource utilized in relation to one or more assignment. The analysis can indicate how (for example how efficiently) collaborative tools were utilized, how certain people (or groups of people) utilized collaborative tools, compare between an assignment resource utilization policy and resources that were presumably utilized in relation to the assignment, and the like.

A person (such as a task owner and executives) can use dashboard 19 to review policy violations or violation alerts, and decide whether to change the assignment resource utilization policy or react otherwise.

It is noted that FIG. 1 illustrated system 10 that had controlling capabilities as well as monitoring capabilities. According to another embodiment of the invention a system is provided for merely monitoring resource utilization. Such a system can include repository 17 but does not necessarily include collaboration controller 16.

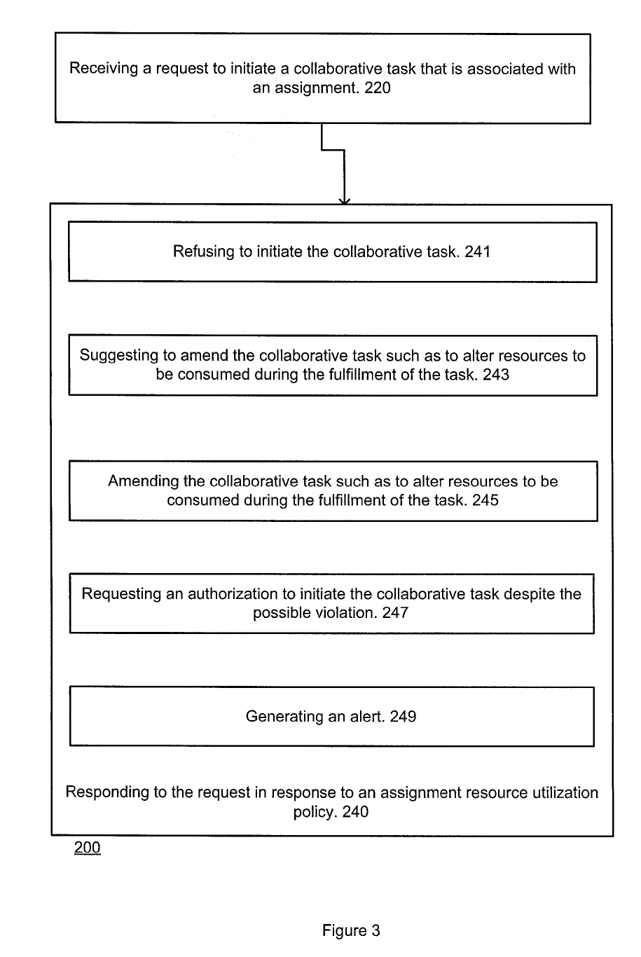

FIG. 3 illustrates method 200 for controlling collaborate tasks, according to an embodiment of the invention.

Method 200 starts by stage 220 of receiving a request to initiate a collaborative task that is associated with an assignment. Referring to the example set forth in FIG. 1, the request can be received by collaboration controller 16.

Stage 220 is followed by stage 240 responding to the request in response to an assignment resource utilization policy. It is noted that the responding can be executed by a collaborative tool, by a control entity or by a combination of both.

Referring to the example set forth in FIG. 1, the responding can be executed by collaboration controller 16 but can be at least partially executed by collaborative tool 13.

Stage 240 can include determining how to respond to the request. The determination can be based upon at least one of the following: (i) resources to be consumed during a fulfillment of the collaborative task, (ii) previous resource utilization related to the assignment, and (iii) assignment resource utilization policy.

The assignment resource utilization policy can limit the resources to be utilized in relation to a certain assignment or in relation to a group of assignments. The assignment resource utilization policy can include one or more resource utilization limitations. Conveniently, a resource utilization limitation can relate to resources that are utilized by certain people, by a certain group of people or by the whole organization. According to an embodiment of the invention a resource utilization limitation can be defined per one or more time windows. These one or more time windows can refer to absolute time periods (months, weeks, days) or to phases in the assignment.

According to yet another embodiment of the invention the assignment resource utilization policy can try to enforce an acceptable resource utilization profile and additionally or additionally try to update the acceptable resource utilization profile.

It is noted that a resource utilization limitation can be absolute (for example—spend up to 100 hours), relative (certain assignment should utilize about 75% of the resources allocated to another assignment), or a combination thereof.

A resource can include time consumed by a person but this is not necessarily so. For example, a resource can be a meeting room, computer infrastructure, storage space, computational power, bandwidth and the like.

It is noted that the assignment resource utilization policy can include soft rules and, additionally or alternatively, hard rules.

The assignment resource utilization policy can define how to manage violations or possible violations of the policy. For example, in case of a possible violation stage 240 can include at least one of the following: (i) stage 241 of refusing to initiate the collaborative task, (ii) stage 243 of suggesting to amend the collaborative task such as to alter resources to be consumed during the fulfillment of the task; (iii) stage 245 of amending the collaborative task such as to alter resources to be consumed during the fulfillment of the task; (iv) stage 247 of requesting an authorization to initiate the collaborative task despite the possible violation; (v) stage 249 generating an alert. Stage 240 can also include taking another action.

Conveniently, a collaborative task is amended such as to reduce the resources to be utilized. The amendment can include, for example, scheduling less meetings, inviting less people to attend a meeting, lowering the rank of people that are invited to participate in a meeting, freeing the busiest people from attending a meeting, and the like.

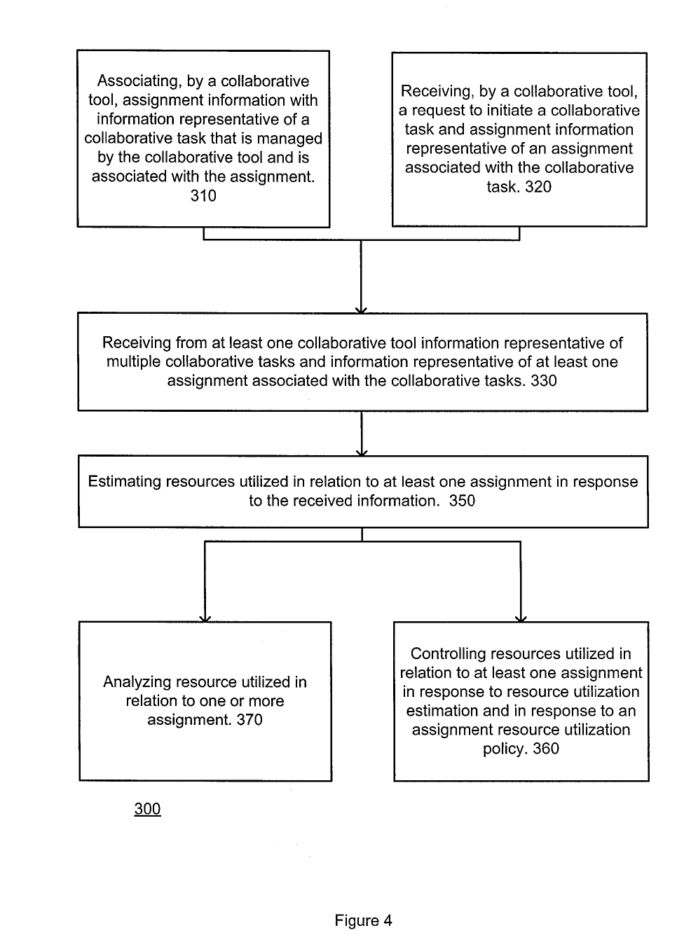

FIG. 4 illustrates method 300 for monitoring collaborate tasks, according to an embodiment of the invention.

Method 300 starts by stage 310 or by stage 320. These stages enable to associate assignment information with collaborative task information. The association can be done by the collaborative tool (stage 310) or by a person (stage 320).

Stage 310 includes associating, by a collaborative tool, assignment information with information representative of a collaborative task that is managed by the collaborative tool and is associated with the assignment.

Stage 320 includes receiving, by a collaborative tool, a request to initiate a collaborative task and assignment information representative of an assignment associated with the collaborative task.

Stages 310 and 320 are followed by stage 330 of receiving from at least one collaborative tool information representative of multiple collaborative tasks and information representative of at least one assignment associated with the collaborative tasks.

Referring to the example set forth in FIG. 1, the assignment information and information representative of a collaborative task are sent from collaborative tool 13 to collaboration controller 16.

Stage 330 is followed by stage 350 of estimating resources utilized in relation to at least one assignment in response to the received information. Accordingly, the assignment information and the collaborative task information are processed to provide the estimation.

The estimating can include evaluating collaborative task information that is non-deterministic in relation to resources utilization. Collaborative task information can include, for example, a length of a scheduled meeting and the number of people (as well as their identities) that are invited to attend the meeting. Additional collaborative task information can include people who accepted the invitation, people who rejected the invitation and people who tentatively accepted the invitation. This collaborative task information does not define who actually attended the meeting, thus is non-deterministic in nature. This non-deterministic information can be processed in order to estimate the resources that were consumed. The estimation can be based upon previous meeting attendance rates, attendance rates that are characteristic of a certain assignment or of a certain person, and the like. The estimation can be responsive to the rank of the employee that initialized the collaborative task, to overlaps between meetings, and the like. The estimation involve applying heuristic and, additionally or alternatively, adaptive methodology.

According to an embodiment of the invention the estimation is based only upon a portion of information representative of multiple collaborative tasks. The sampling (or rather sub-sampling) of only a portion of the task collaboration information can reduce the resources (for example, storage resources or computational resources) allocated to the monitoring.

Stage 350 can be followed by stage 360, and additionally or alternatively, by stage 370.

Stage 370 includes analyzing resource utilized in relation to one or more assignment. The analysis can indicate how (for example how efficiently) collaborative tools were utilized, how certain people (or groups of people) utilized collaborative tools, compare between an assignment resource utilization policy and resources that were utilized in relation to the assignment, and the like.

Referring to the example set forth in FIG. 1, the analysis can be triggered or even preformed by dashboard 19. The analysis can use information stored in repository 17.

Stage 360 includes controlling resources utilized in relation to at least one assignment in response to resource utilization estimation and in response to an assignment resource utilization policy. Stage 360 can include at least one stage of method 200.

Stage 360 can include: (i) receiving, by a collaborative tool, a request to initiate a collaborative task that is associated with an assignment; and (ii) determining whether to initiate the collaborative task in response to an assignment resource utilization policy.

According to another embodiment of the invention method 300 can estimate the resource utilization based upon files or other non-structured information that is exchanged between people that participate in a collaborative task. For example, files attached to emails or to an invitation to attend a meeting can be processed to determine time to be spent in relation to these files. Typically, longer files will consume more time.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Conveniently, a computer program product is provided. The computer program product includes a computer usable medium that includes a computer readable program, wherein the computer readable program when executed on a computer causes the computer to receive a request to initiate a collaborative task that is associated with an assignment; and respond to the request in response to an assignment resource utilization policy.

Conveniently, a computer program product is provided. The computer program product includes a computer usable medium that includes a computer readable program, wherein the computer readable program when executed on a computer causes the computer to receive, from at least one collaborative tool, information representative of multiple collaborative tasks and information representative of at least one assignment associated with the collaborative tasks; and estimate resources utilized in relation to at least one assignment in response to the received information.

The computer readable program can cause the computer to execute one or more states of any method out of methods 200 and 300.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for controlling collaborate tasks, the method comprising:
receiving a request to initiate a collaborative task that is associated with an assignment; and
responding to the request in response to an assignment resource utilization policy.

2. The method according to claim 1 wherein the responding comprises selecting between refusing to initiate the collaborative task, approving an initialization of the collaborative task, and requesting to amend the collaborative task such as to alter resources to be consumed during the collaborative task.

3. The method according to claim 1 further comprising estimating resources utilized in relation to at least one assignment associated with multiple approved collaborative tasks.

4. The method according to claim 1 wherein the responding comprises responding to the request by a collaborative tool that manages the collaborative task.

5. A method for monitoring collaborate tasks, the method comprising:
receiving from at least one collaborative tool information representative of multiple collaborative tasks and information representative of at least one assignment associated with the collaborative tasks; and
estimating resources utilized in relation to at least one assignment in response to the received information.

6. The method according to claim 5 wherein the receiving is preceded by associating, by a collaborative tool, assignment information with information representative of a collaborative task that is managed by the collaborative tool and is associated with the assignment.

7. The method according to claim 5 comprising receiving by a collaborative tool a request to initiate a collaborative task and assignment information representative of an assignment associated with the collaborative task.

8. The method according to claim 5 wherein the estimating comprises evaluating collaborative task information that is non-deterministic in relation to resources utilization.

9. The method according to claim 5 wherein the receiving comprises sampling a portion of information representative of multiple collaborative tasks.

10. The method according to claim 5 further comprising controlling resources utilized in relation to at least one assignment in response to resource utilization estimation and in response to an assignment resource utilization policy.

11. The method according to claim 10 wherein the controlling comprises: receiving, by a collaborative tool, a request to initiate a collaborative task that is associated with an assignment; and determining whether to initiate the collaborative task in response to an assignment resource utilization policy.

12. A computer program product comprising a computer usable medium including a computer readable program, wherein the computer readable program when executed on a computer causes the computer to:
receive a request to initiate a collaborative task that is associated with an assignment; and
respond to the request in response to an assignment resource utilization policy.

13. The computer program product according to claim 12 wherein the computer readable program when executed on a computer causes the computer to select between:
refusing to initiate a collaborative task,
approving an initialization of the collaborative task, and
participate in an amendment of the collaborative task such as to alter resources to be consumed during the collaborative task.

14. The computer program product according to claim 12 wherein the computer readable program when executed on a computer causes the computer to estimate resources utilized in relation to at least one assignment associated with multiple approved collaborative tasks.

15. A computer program product comprising a computer usable medium including a computer readable program, wherein the computer readable program when executed on a computer causes the computer to:
receive, from at least one collaborative tool, information representative of multiple collaborative tasks and information representative of at least one assignment associated with the collaborative tasks; and
estimate resources utilized in relation to at least one assignment in response to the received information.

16. The computer program product according to claim 15 wherein the computer readable program when executed on a computer causes the computer to evaluate collaborative task information that is non-deterministic in relation to resources utilization.

17. The computer program product according to claim 15 wherein the computer readable program when executed on a computer causes the computer to sample a portion of information representative of multiple collaborative tasks.

18. The computer program product according to claim 15 wherein the computer readable program when executed on a computer causes the computer to control resources utilized in relation to at least one assignment in response to resource utilization estimation and in response to an assignment resource utilization policy.

19. The computer program product according to claim 18 wherein the computer readable program when executed on a computer causes the computer to determine whether to initiate the collaborative task in response to an assignment resource utilization policy.

20. The computer program product according to claim 15, wherein the computer readable program when executed on a computer causes the computer to analyze resources utilized in relation to different assignments.
